(19) United States
(12) Patent Application Publication
(10) Pub. No.: US 2024/0178393 A1
(43) Pub. Date: May 30, 2024

(54) SULFUR-CONTAINING POSITIVE ELECTRODE MATERIAL FOR SECONDARY BATTERY, PREPARATION METHOD THEREOF, AND SECONDARY BATTERY

(71) Applicant: SHANGHAI JIAO TONG UNIVERSITY, Shanghai (CN)

(72) Inventors: Jiulin WANG, Shanghai (CN); Jingyu LEI, Shanghai (CN); Jun YANG, Shanghai (CN)

(73) Assignee: SHANGHAI JIAO TONG UNIVERSITY, Shanghai (CN)

(21) Appl. No.: 18/283,457

(22) PCT Filed: Mar. 2, 2022
(86) PCT No.: PCT/CN2022/078705

§ 371 Date: Sep. 22, 2023

(30) Foreign Application Priority Data
May 24, 2021 (CN) 202110566526.6

(51) Int. Cl. H01M 4/60; C08J 3/24; H01M 4/02; H01M 4/04; H01M 10/054

(52) U.S. Cl. CPC H01M 4/604; C08J 3/247; H01M 4/0471; H01M 10/054; C08J 2333/20; H01M 2004/021; H01M 2004/027; H01M 2004/028

(57) ABSTRACT

The present invention relates to a sulfur-containing positive electrode material for a secondary battery, a preparation method thereof, and a secondary battery. The sulfur-containing positive electrode material is obtained by uniformly mixing microporous polyacrylonitrile (with a pore diameter of 0.2-2 nm) as a precursor with elemental sulfur and then performing heating treatment. The microporous polyacrylonitrile is obtained through free radical polymerization of an acrylonitrile monomer and a crosslinking agent.

### BACKGROUND OF THE INVENTION

### Technical Field

The present invention relates to a sulfur-containing positive material, and in particular to a sulfur-containing positive material capable of being assembled with a lithium, sodium, potassium, magnesium, calcium or aluminum negative electrode to a secondary battery and a preparation method thereof. The present invention further relates to the secondary battery containing the sulfur-containing positive material.

### Description of Related Art

A secondary battery taking lithium, sodium, potassium, magnesium or aluminum as a negative electrode and sulfur as a positive electrode has the significant advantages of high energy density, an abundant sulfur resources, low cost, environmental optimization and the like. Taking a lithium-sulfur battery as an example, due to the theoretical energy density as high as 2600 Wh/kg and the characteristics of low cost and environmental friendliness, the lithium-sulfur battery has received extensive attention. As early as 2002, the document (J. Wang et al, Advanced materials, 2002, 13-14, 963) reported for the first time that sulfur and polyacrylonitrile (PAN) reacted at a high temperature to prepare vulcanized polyacrylonitrile (S@PAN) composite positive electrode material. The positive electrode material has no polysulfide ion dissolution and shuttling phenomenon in a carbonate-based electrolyte, high charge and discharge efficiency, low self-discharge, stable cycle and excellent rate performance. However, when linear polyacrylonitrile is used as a precursor, the sulfur content in the obtained S@PAN positive electrode material is limited, less than 50 wt %, usually around 45 wt %, resulting in a low specific capacity of the material and affecting the energy density of the secondary battery. Therefore, it is of great significance to improve the energy density of secondary batteries by preparing S@PAN positive electrode material with high sulfur content and high specific capacity.

### Related Prior Art Documents

(1) Chinese patent CN106957443A discloses a polyacrylonitrile-sulfur-composite material with improved electric capacity;
(2) the document (Science advances. 2018, 4(6):eaat1687) discloses a pyrolysis polyacrylonitrile/selenium disulfide composite; and
(3) the document (The Journal of Physical Chemistry C. 2017, 121, 26172-26179) discloses a mesoporous polymer synthesized by a molecular sieve SBA-15 hard template.

### BRIEF SUMMARY OF THE INVENTION

After in-depth research, the applicant of the present invention found that:

in the polyacrylonitrile-sulfur-composite material with improved electric capacity, disclosed by Chinese patent CN106957443A, using polyacrylonitrile and sulfur to react with at least one crosslinking agent, is a polymer particle surface modification technology, which cannot affect the interiors of the polymer particles and has limited effect on increasing the sulfur content.

In the pyrolysis polyacrylonitrile/selenium disulfide composite disclosed by the document (Science advances, 2018, 4(6):eaat1687), mesoporous pores with a pore diameter of 2-50 nm are formed through electrostatic spinning, even macropores of 100 nm, but the size of the sulfur molecules is about 1 nm, which is not suitable for accommodating monodispersed sulfur molecules, that is, amorphous sulfur cannot be formed.

In the mesoporous polymer synthesized by the molecular sieve SBA-15 hard template, disclosed by the document (The Journal of Physical Chemistry C. 2017, 121, 26172-26179), the pore diameter is 2-50 nm. Since the size of sulfur molecules is only 1 nm and the pore diameter exceeds 2 nm, the filled sulfur is a molecular aggregate, and the electrochemical reaction kinetics will be very slow, so the mesopore is not suitable for accommodating monodispersed sulfur molecules.

An objective of the present invention is to provide a sulfur-containing positive electrode material for a secondary battery, a preparation method of the sulfur-containing positive electrode material, and the secondary battery.

The present invention starts with the precursor of polyacrylonitrile (PAN), and constructs polyacrylonitrile with abundant micropores (with a pore diameter less than 2 nm). A large number of micropores can accommodate sulfur materials, thereby significantly increasing the sulfur content in vulcanized polyacrylonitrile, that is, the specific capacity of the positive electrode of the battery; furthermore, the method is simple, easy to enlarge, and high in practicability.

The objective of the present invention may be achieved by the following technical solutions:
a first aspect of the present invention provides a sulfur-containing positive electrode material for a secondary battery, including sulfur and microporous polyacrylonitrile, where the microporous polyacrylonitrile is obtained through polymerization reaction of an acrylonitrile monomer and a crosslinking agent, which is also referred to as crosslinked polyacrylonitrile (CPAN).

Preferably, the pore diameter of the microporous polyacrylonitrile is 0.2-2 nm, but does not contain 2 nm.

Preferably, the polymerization reaction of the microporous polyacrylonitrile further includes the following raw materials: an initiator, a surfactant and a solvent; and the mass ratio of the acrylonitrile monomer to the initiator to the cross-linking agent to the surfactant to the solvent is 1:(0.01-0.1):(0.01-0.1):(0.01-0.1):(4-10).

Preferably, the crosslinking agent is one or more of divinyl benzene, poly(diallyl phthalate), ethylene glycol dimethacrylate. 1,4-butylene glycol diacrylate, polyethylene glycol dimethacrylate and polyethylene glycol diacrylate.

Preferably, the initiator is one or more of potassium persulfate, ammonium persulfate, azobisisobutyronitrile (AIBN) and dibenzoyl peroxide (BPO).

Preferably, the surfactant is one or more of sodium dodecylsulfonate (SDS), polyvinylpyrrolidone (PVP), polyvinyl alcohol (PVA) and cetyltrimethylammonium bromide (CTAB).

Preferably, the solvent is one or more of water, toluene, ethylbenzene, dimethylsulfoxide (DMSO), N,N-dimethylformamide (DMF) and N, N-dimethylacetamide (DMAC).

Preferably, the time of the polymerization reaction is 3-12 h, and the temperature of the polymerization reaction is 50° C.-100° C.

The initiator, crosslinking agent, surfactant and solvent used, as well as the polymerization temperature and time process conditions have an important impact on the microporous polyacrylonitrile.

A second aspect of the present invention is to provide a preparation method of the sulfur-containing positive electrode material for the secondary battery. Elemental sulfur and microporous polyacrylonitrile are mixed according to a mass ratio of (2-16):1, the mixture is heated to 250° C.-450° C., and heat preservation is performed for 1-16 h to obtain a vulcanized polyacrylonitrile positive electrode material, that is, the sulfur-containing positive electrode material for the secondary battery.

Preferably, in the preparation method, the elemental sulfur and the microporous polyacrylonitrile are mixed according to a mass ratio of (3-8):1, the mixture is heated to 300° C.-400° C., and heat preservation is performed for 4-10 h to obtain a vulcanized polyacrylonitrile positive electrode material, that is, the sulfur-containing positive electrode material for the secondary battery.

Preferably, in the sulfur-containing positive electrode material for the secondary battery, the sulfur content is 45-70 wt %. Preferably, the sulfur content is 50-65 wt %.

A third aspect of the present invention provides a secondary battery, having a negative electrode and a positive electrode. The positive electrode includes the sulfur-containing positive electrode material for the secondary battery.

Preferably, the negative electrode is lithium, sodium, potassium, magnesium, calcium or aluminum.

Preferably, the positive electrode is obtained by the following preparation method: an adhesive, the sulfur-containing positive electrode material for the secondary battery and a conductive agent are uniformly dispersed into a solvent according to a mass ratio of (7-9):(0.5-1.5):(0.5-1.5) and then coated on a current collector, and drying and tabletting are performed to obtain the positive electrode.

As the microporous polyacrylonitrile has a porous structure, the specific surface area is large and more space is provided for sulfur molecules, so that the obtained vulcanized polyacrylonitrile positive electrode material has high sulfur content and large specific capacity when being used as a secondary battery positive electrode, and the energy density of the secondary battery is significantly improved; and the preparation method is simple and easy to implement, environment-friendly, low in cost, high in practical value and large in application prospect.

Compared with the prior art, the present invention has the following beneficial effects:
in the prior art, when the sulfur content of the sulfur material S@pPAN prepared from linear polyacrylonitrile as the precursor exceeds 50 wt %, a large amount of sulfur will be adsorbed on the surface of the sulfur material S@pPAN, thereby affecting the cycle performance and the rate discharge capacity of the material. According to the present invention, the acrylonitrile monomer and the crosslinking agent are polymerized to form the microporous polyacrylonitrile, the pore diameter of 0.2-2 nm (and does not contain 2 nm). Compared with the linear polyacrylonitrile, the specific surface area is increased by 18.5 times. The abundant microporous structures provide additional space for the sulfur. In the high-temperature sintering process, the polyacrylonitrile micropores can be filled with a large number of sulfur molecules. The sulfur content of the prepared S@pPAN reaches 70 wt %, and the reversible specific capacity of the material reaches 818 mAh g⁻¹. Significant effect, simple process, easy enlargement and high practicability are achieved.

### BRIEF DESCRIPTION OF THE SEVERAL VIEWS OF THE DRAWINGS

FIG. 1 is a transmission electron microscopy image of linear polyacrylonitrile (a), microporous crosslinked polyacrylonitrile (b) obtained in Embodiment 1, a corresponding sulfur positive electrode material S@pPAN (c) prepared from the linear polyacrylonitrile as a precursor, and a corresponding sulfur positive electrode material S@pCPAN (d) prepared from microporous polyacrylonitrile as a precursor;

FIG. 2 is an adsorption and desorption curve comparative diagram of linear polyacrylonitrile PAN in a comparative embodiment, microporous polyacrylonitrile CPAN obtained in Embodiment 2 and a prepared positive electrode material;

FIG. 3 is a pore diameter distribution curve comparative diagram of linear polyacrylonitrile PAN in a comparative embodiment, microporous polyacrylonitrile CPAN obtained in Embodiment 2 and a prepared positive electrode material;

FIG. 4 is a cycle comparative diagram of a vulcanized polyacrylonitrile positive electrode material prepared from linear polyacrylonitrile PAN and microporous polyacrylonitrile CPAN obtained in Embodiment 3 as precursors; and

FIG. 5 is a cycle rate comparative diagram of a vulcanized polyacrylonitrile positive electrode material prepared from linear polyacrylonitrile PAN and microporous polyacrylonitrile CPAN obtained in Embodiment 3 as precursors.

### DETAILED DESCRIPTION OF THE INVENTION

A sulfur-containing positive electrode material for a secondary battery includes sulfur and microporous polyacrylonitrile. The microporous polyacrylonitrile is obtained through polymerization reaction of an acrylonitrile monomer and a crosslinking agent, which is also referred to as crosslinked polyacrylonitrile (CPAN).

As a preferred embodiment of the present invention, the pore diameter of the microporous polyacrylonitrile is 0.2-2 nm, but does not contain 2 nm.

As a preferred embodiment of the present invention, the polymerization reaction of the microporous polyacrylonitrile further includes the following raw materials: an initiator, a surfactant and a solvent; and the mass ratio of the acrylonitrile monomer to the initiator to the cross-linking agent to the surfactant to the solvent is 1:(0.01-0.1):(0.01-0.1):(0.01-0.1):(4-10). As a preferred embodiment of the present invention, the crosslinking agent is one or

more of divinyl benzene, poly(diallyl phthalate), ethylene glycol dimethacrylate, 1,4-butylene glycol diacrylate, polyethylene glycol dimethacrylate and polyethylene glycol diacrylate.

As a preferred embodiment of the present invention, the initiator is one or more of potassium persulfate, ammonium persulfate, azobisisobutyronitrile (AIBN) and dibenzoyl peroxide (BPO).

As a preferred embodiment of the present invention, the surfactant is one or more of sodium dodecylsulfonate (SDS), polyvinylpyrrolidone (PVP), polyvinyl alcohol (PVA) and cetyltrimethylammonium bromide (CTAB).

As a preferred embodiment of the present invention, the solvent is one or more of water, toluene, ethylbenzene, dimethylsulfoxide (DMSO), N,N-dimethylformamide (DMF) and N. N-dimethylacetamide (DMAC).

As a preferred embodiment of the present invention, the time of the polymerization reaction is 3-12 h, and the temperature of the polymerization reaction is 50° C.-100° C.

According to a preparation method of the sulfur-containing positive electrode material for the secondary battery, elemental sulfur and microporous polyacrylonitrile are mixed according to a mass ratio of (2-16):1, the mixture is heated to 250° C.-450° C., and heat preservation is performed for 1-16 h to obtain a vulcanized polyacrylonitrile positive electrode material, that is, the sulfur-containing positive electrode material for the secondary battery.

As a preferred embodiment of the present invention, the elemental sulfur and the microporous polyacrylonitrile are mixed according to a mass ratio of (3-8):1, the mixture is heated to 300° C.-400° ° C., and heat preservation is performed for 4-10 h to obtain a vulcanized polyacrylonitrile positive electrode material, that is, the sulfur-containing positive electrode material for the secondary battery.

As a preferred embodiment of the present invention, in the sulfur-containing positive electrode material for the secondary battery, the sulfur content is 45-70 wt %. Preferably, the sulfur content is 50-65 wt %.

A secondary battery has a negative electrode and a positive electrode. The positive electrode includes the sulfur-containing positive electrode material for the secondary battery.

As a preferred embodiment of the present invention, the negative electrode is lithium, sodium, potassium, magnesium, calcium or aluminum.

As a preferred embodiment of the present invention, the positive electrode is obtained by the following preparation method: an adhesive, the sulfur-containing positive electrode material for the secondary battery and a conductive agent are uniformly dispersed into a solvent according to a mass ratio of (7-9):(0.5-1.5):(0.5-1.5) and then coated on a current collector, and drying and tabletting are performed to obtain the positive electrode.

The present invention is described in detail below with reference to the accompanying drawings and specific examples.

### Embodiment 1

5 g of acrylonitrile. 0.25 g of AIBN, 0.2 g of 1,4-butylene glycol diacrylate and 0.5 g of PVP were added into 50 ml of DMAC and were subjected to magnetic stirring at 80° C. for 4 h to generate a white precipitate, and the white precipitate was washed with hydrochloric acid/acetone mixed liquid and distilled water and then was dried to obtain microporous polyacrylonitrile. 2 g of the obtained microporous polyacrylonitrile and 32 g of elemental sulfur were added into ethanol for ball milling for 3 h, and powder obtained after drying was heated for 5 h in a tubular furnace at 300° C. in a nitrogen atmosphere to obtain a polyacrylonitrile positive electrode material, where the sulfur content of the material is 70 wt %.

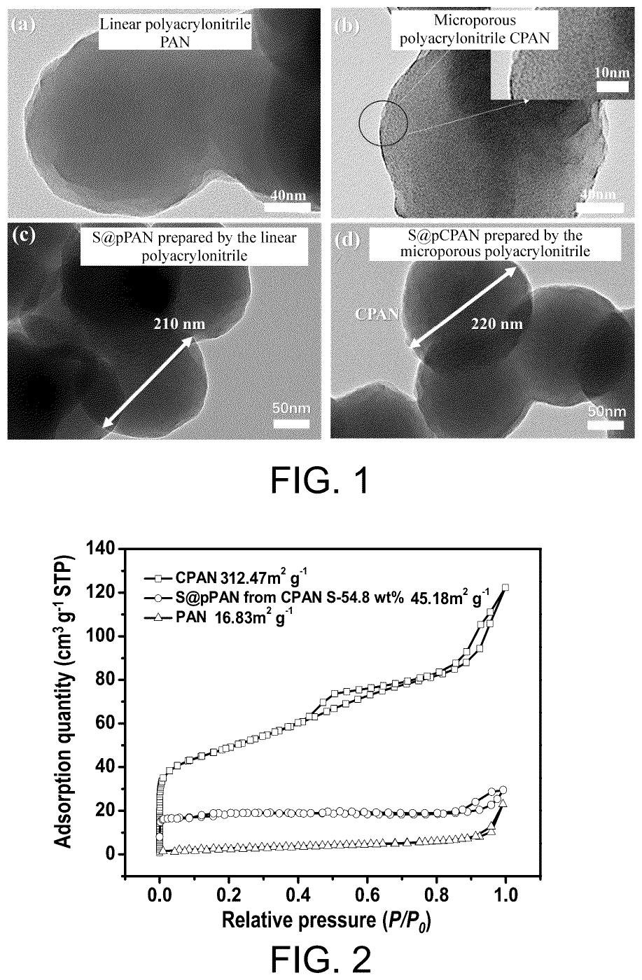

The transmission electron microscopy images of the microporous crosslinked polyacrylonitrile prepared by this embodiment and a corresponding sulfur positive electrode material S@pCPAN prepared from the microporous polyacrylonitrile as a precursor are shown in FIG. 1(b) and FIG. 1(d).

Battery assembly and test are as follows: metal lithium is used as a negative electrode to assemble a lithium-sulfur secondary battery, electrolyte is 1M of LiPF₆/EC:DMC (1:1 volume ratio, EC: ethylene carbonate, DMC: dimethyl carbonate), and the charge and discharge cut-off voltage is 1-3 V (vs. Li⁺/Li). The first discharge specific capacity is 1150.8 mAh g⁻¹.

### Embodiment 2

5 g of acrylonitrile. 0.1 g of ammonium persulfate. 0.1 g of ethylene glycol dimethacrylate and 0.25 g of SDS were added into 40 ml of water/DMSO(m:m=1:1) and were subjected to magnetic stirring at 60° C. for 10 h to generate a white precipitate, and the white precipitate was washed with hydrochloric acid/acetone mixed liquid and distilled water and then was dried to obtain microporous polyacrylonitrile.

2 g of the obtained microporous polyacrylonitrile and 4 g of elemental sulfur were added into ethanol for ball milling for 3 h, and powder obtained after drying was heated for 10 h in a tubular furnace at 250° C. in a nitrogen atmosphere to obtain a polyacrylonitrile positive electrode material, where the sulfur content of the material is 45.1 wt %.

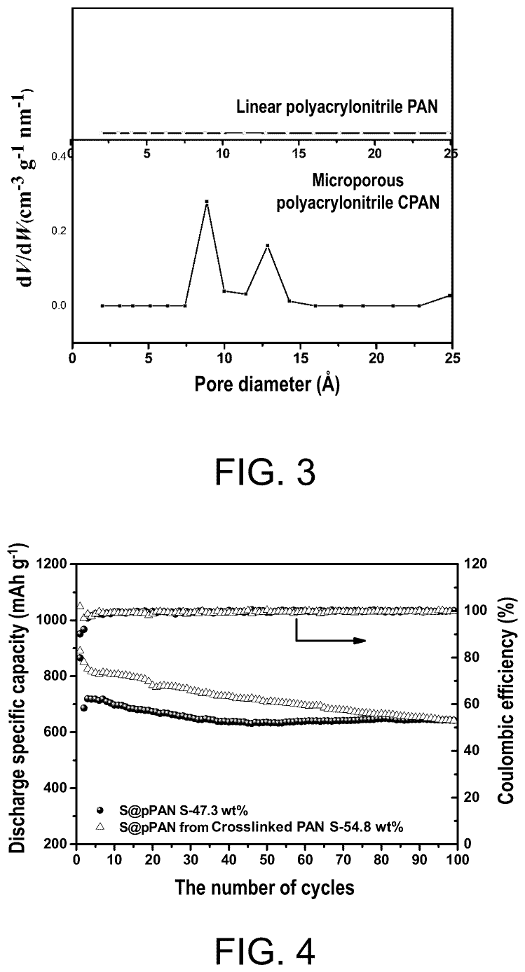

The adsorption and desorption curve of the microporous polyacrylonitrile CPAN obtained in this embodiment and the positive electrode material is shown in FIG. 2. The pore diameter distribution of the microporous polyacrylonitrile CPAN obtained in this embodiment and the positive electrode material is shown in FIG. 3.

Battery assembly and test are as follows: metal lithium is used as a negative electrode to assemble a lithium-sulfur secondary battery, electrolyte is 1M of LiPF₆/EC:DMC (1:1 volume ratio. EC: ethylene carbonate. DMC: dimethyl carbonate), and the charge and discharge cut-off voltage is 1-3 V (vs. Li⁺/Li). The specific capacity under the condition of 0.2 C rate reaches 732 mAh g⁻¹.

### Embodiment 3

5 g of acrylonitrile. 0.05 g of potassium persulfate. 0.05 g of divinyl benzene and 0.1 g of PVA were added into 20 ml of water and were subjected to magnetic stirring at 65° C. for 5 h to generate a white precipitate, and the white precipitate was washed with hydrochloric acid/acetone mixed liquid and distilled water and then was dried to obtain microporous polyacrylonitrile.

2 g of the prepared microporous polyacrylonitrile and 16 g of elemental sulfur were added into ethanol for ball milling for 3 h, and powder obtained after drying was heated for 5 h in a tubular furnace at 300° C. in a nitrogen atmosphere to obtain a polyacrylonitrile positive electrode material, where the sulfur content of the material is 54.8 wt %.

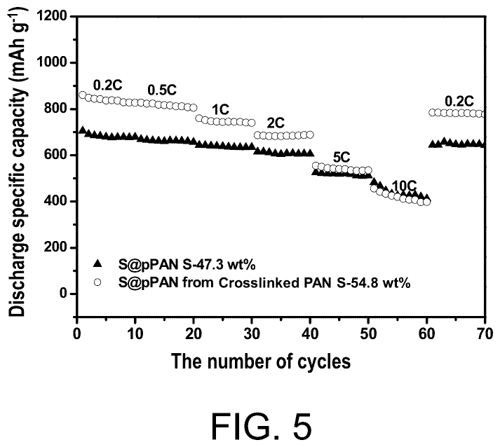

Battery assembly and test are as follows: metal lithium is used as a negative electrode to assemble a lithium-sulfur secondary battery, electrolyte is 1M of LiPF₆/EC:DMC (1:1 volume ratio. EC: ethylene carbonate, DMC: dimethyl carbonate), and the charge and discharge cut-off voltage is 1-3 V (vs. Li⁺/Li). Under the condition of 0.2 C rate, the first discharge specific capacity is 1048.8 mAh g⁻¹, and the reversible specific capacity is 849.9 mAh g⁻¹, as shown in FIG. 4. The large-rate discharge capacity is shown in FIG. 5.

### Embodiment 4

5 g of acrylonitrile. 0.1 g of BPO. 0.5 g of polyethylene glycol dimethacrylate and 0.25 g of SDS were added into 40 ml of water/DMSO(m:m=1:1) and were subjected to magnetic stirring at 50° ° C. for 12 h to generate a white precipitate, and the white precipitate was washed with hydrochloric acid/acetone mixed liquid and distilled water and then was dried to obtain microporous polyacrylonitrile.

2 g of the obtained microporous polyacrylonitrile and 10 g of elemental sulfur were added into ethanol for ball milling for 3 h, and powder obtained after drying was heated for 1 h in a tubular furnace at 450° C. in a nitrogen atmosphere to obtain a polyacrylonitrile positive electrode material, where the sulfur content of the material is 65.2 wt %.

Battery assembly and test are as follows: metal lithium is used as a negative electrode to assemble a sodium-sulfur secondary battery, electrolyte is 1M of NaPF₆/EC:DMC (1:1 volume ratio, EC: ethylene carbonate, DMC: dimethyl carbonate), and the charge and discharge cut-off voltage is 1-2.7V (vs. Na+/Na). The specific capacity under the condition of 0.2 C rate reaches 620 mAh g⁻¹.

### Embodiment 5

5 g of acrylonitrile. 0.5 g of potassium persulfate. 0.05 g of polyethylene glycol diacrylate and 0.05 g of PVP were added into 50 ml of ethylbenzene and were subjected to magnetic stirring at 65° C. for 5 h to generate a white precipitate, and the white precipitate was washed with hydrochloric acid/acetone mixed liquid and distilled water and then was dried to obtain microporous polyacrylonitrile.

2 g of the obtained microporous polyacrylonitrile and 6 g of elemental sulfur were added into ethanol for ball milling for 3 h, and powder obtained after drying was heated for 5 h in a tubular furnace at 300° C. in a nitrogen atmosphere to obtain a polyacrylonitrile positive electrode material, where the sulfur content of the material is 55.5.

Battery assembly and test are as follows: metal lithium is used as a negative electrode to assemble a sodium-sulfur secondary battery, electrolyte is 1M of NaPF₆/EC:DMC (1:1 volume ratio. EC: ethylene carbonate, DMC: dimethyl carbonate), and the charge and discharge cut-off voltage is 1-2.7V (vs. Na⁺/Na). The specific capacity under the condition of 0.2 C rate reaches 550 mAh g⁻¹.

### Embodiment 6

5 g of acrylonitrile. 0.1 g of AIBN. 0.1 g of polyethylene glycol dimethacrylate. 0.05 g of divinyl benzene and 0.1 g of PVP were added into 30 ml of water/DMAC(m:m=1:1) and were subjected to magnetic stirring at 60° C. for 5 h to generate a white precipitate, and the white precipitate was washed with hydrochloric acid/acetone mixed liquid and distilled water and then was dried to obtain intramolecular crosslinked polyacrylonitrile.

2 g of the obtained intramolecular crosslinked polyacrylonitrile and 10 g of elemental sulfur were added into ethanol for ball milling for 3 h, and powder obtained after drying was heated for 10 h in a tubular furnace at 400° C. in a nitrogen atmosphere to obtain a polyacrylonitrile positive electrode material, where the sulfur content of the material is 45 wt %.

### Embodiment 7

5 g of acrylonitrile. 0.1 g of ammonium persulfate. 0.2 g of 1,4-butylene glycol diacrylate and 0.25 g of CTAB were added into 50 ml of DMSO and were subjected to magnetic stirring at 100° C. for 3 h to generate a white precipitate, and the white precipitate was washed with hydrochloric acid/acetone mixed liquid and distilled water and then was dried to obtain microporous polyacrylonitrile.

2 g of the obtained microporous polyacrylonitrile and 16 g of elemental sulfur were added into ethanol for ball milling for 3 h, and powder obtained after drying was heated for 10 h in a tubular furnace at 300° C. in a nitrogen atmosphere to obtain a polyacrylonitrile positive electrode material, where the sulfur content of the material is 46.73.

### Embodiment 8

5 g of acrylonitrile. 0.2 g of BPO. 0.5 g of polyethylene glycol dimethacrylate and 0.5 g of SDS were added into 30 ml of ethylbenzene and were subjected to magnetic stirring at 65° C. for 5 h to generate a white precipitate, and the white precipitate was washed with hydrochloric acid/acetone mixed liquid and distilled water and then was dried to obtain microporous polyacrylonitrile.

2 g of the obtained microporous polyacrylonitrile and 16 g of elemental sulfur were added into ethanol for ball milling for 3 h, and powder obtained after drying was heated for 10 h in a tubular furnace at 300° C. in a nitrogen atmosphere to obtain a polyacrylonitrile positive electrode material, where the sulfur content of the material is 47.2 wt %.

### Embodiment 9

5 g of acrylonitrile. 0.05 g of potassium persulfate. 0.05 g of polyethylene glycol diacrylate. 0.05 g of divinyl benzene and 0.5 g of CTAB were added into 30 ml of water/DMF(m:m=1:1) and were subjected to magnetic stirring at 60° ° C. for 5 h to generate a white precipitate, and the white precipitate was washed with hydrochloric acid/acetone mixed liquid and distilled water and then was dried to obtain microporous polyacrylonitrile.

2 g of the obtained microporous polyacrylonitrile and 16 g of elemental sulfur were added into ethanol for ball milling for 3 h, and powder obtained after drying was heated for 10 h in a tubular furnace at 300° C. in a nitrogen atmosphere to obtain a polyacrylonitrile positive electrode material, where the sulfur content of the material is 56.6 wt %.

### Embodiment 10

5 g of acrylonitrile. 0.5 g of potassium persulfate. 0.1 g of divinyl benzene and 0.1 g of CTAB were added into 40 ml of water/DMSO(m:m=1:1) and were subjected to magnetic stirring at 75° C. for 5 h to generate a white precipitate, and the white precipitate was washed with hydrochloric acid/acetone mixed liquid and distilled water and then was dried to obtain microporous polyacrylonitrile.

2 g of the obtained microporous polyacrylonitrile and 16 g of elemental sulfur were added into ethanol for ball milling for 3 h, and powder obtained after drying was heated for 5 h in a tubular furnace at 400° C. in a nitrogen atmosphere to obtain a polyacrylonitrile positive electrode material, where the sulfur content of the material is 55.2 wt %.

### Embodiment 11

5 g of acrylonitrile. 0.1 g of AIBN, 0.25 g of 1,4-butylene glycol diacrylate and 0.5 g of SDS were added into 30 ml of methylbenzene and were subjected to magnetic stirring at 50° C. for 12 h to generate a white precipitate, and the white precipitate was washed with hydrochloric acid/acetone mixed liquid and distilled water and then was dried to obtain microporous polyacrylonitrile.

2 g of the obtained microporous polyacrylonitrile and 16 g of elemental sulfur were added into ethanol for ball milling for 3 h, and powder obtained after drying was heated for 16 h in a tubular furnace at 300° C. in a nitrogen atmosphere to obtain a polyacrylonitrile positive electrode material, where the sulfur content of the material is 46.4 wt %.

### Comparative Embodiment

Linear polyacrylonitrile was prepared without adding a crosslinking agent. 5 g of acrylonitrile and 0.05 g of potassium persulfate were added into 20 ml of water and were subjected to magnetic stirring at 65° C. for 5 h to generate a white precipitate, and the white precipitate was washed with hydrochloric acid/acetone mixed liquid and distilled water and then was dried to obtain the linear polyacrylonitrile. The transmission electron microscopy image is shown in FIG. 1(a), the absorption and desorption curve is shown in FIG. 2, and the pore diameter distribution is shown in FIG. 3.

2 g of the prepared linear polyacrylonitrile and 16 g of elemental sulfur were added into ethanol for ball milling for 3 h, and powder obtained after drying was heated for 5 h in a tubular furnace at 300° C. in a nitrogen atmosphere to obtain a vulcanized polyacrylonitrile positive electrode material, where the sulfur content of the material is 47.3 wt %. The transmission electron microscopy image of the vulcanized polyacrylonitrile positive electrode material is shown in FIG. 1 (c).

Battery assembly and test are as follows: metal lithium is used as a negative electrode to assemble a lithium-sulfur secondary battery, electrolyte is 1M of LiPF₆/EC:DMC (1:1 volume ratio. EC: ethylene carbonate. DMC: dimethyl carbonate), and the charge and discharge cut-off voltage is 1-3V(vs.Li⁺/Li). Under the condition of 0.2 C rate, the first discharge specific capacity is 951.2 mAh g⁻¹, and the reversible specific capacity is 718.9 mAh g⁻¹ (FIG. 4). The cycle rate performance is shown in FIG. 5.

Table 1 shows the property comparison of the linear polyacrylonitrile PAN prepared in the comparative embodiment, the microporous polyacrylonitrile CPAN prepared in Embodiment 2 and Embodiment 3, and the corresponding sulfur-containing material.

TABLE 1

| | Linear | Microporous | | |
|---|---|---|---|---|
| | Polyacry- | Polyacry- | | |
| | lonitrile | lonitrile | | |
| Sample | PAN | CPAN | S@pPAN | S@pCPAN |
| Specific surface | 16.83 | 312.47 | 21.56 | 45.18 |
| area (m²g⁻1) | | | | |
| Pore Volume | 0.038 | 0.530 | / | 0.051 |
| (cm³g⁻¹) | | | | |
| Feature Pore | / | 0.88 | / | / |
| Diameter | | | | |
| First Discharge | / | / | 951.2 | 1048.8 |
| Specific Capacity | | | | |
| (mAh g⁻¹) | | | | |
| Reversible Specific | / | / | 718.9 | 849.9 |
| Capacity (mAh g⁻¹) | | | | |

FIG. 1 is a transmission electron microscopy image of linear polyacrylonitrile (a), microporous crosslinked polyacrylonitrile (b), a corresponding sulfur positive electrode material S@pPAN (c) prepared from the linear polyacrylonitrile as a precursor, and a corresponding sulfur positive electrode material S@pCPAN (d) prepared from microporous polyacrylonitrile as a precursor. It can be seen from FIG. 1(a) that linear PAN is of a dense structure; and the pore diameter of the microporous PAN prepared by the crosslinking method in FIG. 1(b) is between 0.75 nm and 1.5 nm.

FIG. 2 is an adsorption and desorption curve comparative diagram of linear polyacrylonitrile PAN in a comparative embodiment, microporous polyacrylonitrile CPAN obtained in Embodiment 2 and a prepared positive electrode material; It can be seen that the specific surface area of the linear PAN is 16.8 m² g⁻¹, and in the microporous PAN prepared by the crosslinking method, the specific surface area is increased by 18 times due to the presence of a large number of micropores.

FIG. 3 is a pore diameter distribution curve comparative diagram of linear polyacrylonitrile PAN in a comparative embodiment, microporous polyacrylonitrile CPAN obtained in Embodiment 2 and a prepared positive electrode material; Consistent with the morphological structure in FIG. 1, the linear PAN is of a dense structure; and the pore diameter of the microporous PAN prepared by the crosslinking method is between 0.75 nm and 1.5 nm.

FIG. 4 is a cycle comparative diagram of a vulcanized polyacrylonitrile positive electrode material prepared from linear polyacrylonitrile PAN and microporous polyacrylonitrile CPAN obtained in Embodiment 3 as precursors; and it can be seen from the figure that since the abundant microporous structures can accommodate more monodispersed sulfur molecules, the sulfur content is effectively increased (from 47.3% to 54.8%), the corresponding first discharge specific capacity is 1048.8 mAh g⁻¹, and the reversible specific capacity is 849.9 mAh g⁻¹; and in the comparative sample, the first discharge specific capacity is 951.2 mAh g⁻¹, and the reversible specific capacity is 718.9 mAh g⁻¹.

The above description of the embodiments is convenient for those of ordinary skill in the art to understand and use the present invention. Those skilled in the art obviously may easily make various modifications on these embodiments, and may apply the general principles described herein to other embodiments without creative effort. Therefore, the present invention is not limited to the above embodiments. The improvements and modifications made by those skilled in the art according to the disclosure of the present invention without departing from the scope of the present invention should be within the protection scope of the present invention.

1. A sulfur-containing positive electrode material for a secondary battery, comprising sulfur and microporous polyacrylonitrile,
wherein the microporous polyacrylonitrile is obtained through a polymerization reaction of an acrylonitrile monomer and a crosslinking agent.

2. The sulfur-containing positive electrode material for a secondary battery according to claim 1, wherein a pore diameter of the microporous polyacrylonitrile is 0.2-2 nm and excludes 2 nm.

3. The sulfur-containing positive electrode material for a secondary battery according to claim 1, wherein the polymerization reaction of the microporous polyacrylonitrile further comprises the following raw materials: an initiator, a surfactant and a solvent; and
a mass ratio of the acrylonitrile monomer, the initiator, the crosslinking agent, the surfactant and the solvent is 1:(0.01-0.1):(0.01-0.1):(0.01-0.1):(4-10).

4. The sulfur-containing positive electrode material for a secondary battery according to claim 1, wherein the crosslinking agent is one or more of divinyl benzene, poly(diallyl phthalate), ethylene glycol dimethacrylate, 1,4-butylene glycol diacrylate, polyethylene glycol dimethacrylate and polyethylene glycol diacrylate.

5. The sulfur-containing positive electrode material for a secondary battery according to claim 3, comprising one or more of the following conditions:
(i) the initiator is one or more of potassium persulfate, ammonium persulfate, azobisisobutyronitrile and dibenzoyl peroxide;
(ii) the surfactant is one or more of sodium dodecylsulfonate, polyvinylpyrrolidone, polyvinyl alcohol and cetyltrimethylammonium bromide; and
(iii) the solvent is one or more of water, toluene, ethylbenzene, dimethylsulfoxide, N,N-dimethylformamide and N, N-dimethylacetamide.

6. The sulfur-containing positive electrode material for a secondary battery according to claim 1, wherein a time of the polymerization reaction is 3-12 h, and a temperature of the polymerization reaction is 50° C.-100° C.

7. A preparation method of the sulfur-containing positive electrode material for a secondary battery according to claim 1, wherein elemental sulfur and microporous polyacrylonitrile are mixed according to a mass ratio of (2-16):1, heated to 250° C.-450° ° C. and heat preserved for 1-16 h to obtain a vulcanized polyacrylonitrile positive electrode material, that is, the sulfur-containing positive electrode material for the secondary battery.

8. The preparation method of the sulfur-containing positive electrode material for a secondary battery according to claim 7, wherein in the sulfur-containing positive electrode material for the secondary battery, a sulfur content is 45-70 wt %.

9. A secondary battery, having a negative electrode and a positive electrode, wherein the positive electrode comprises the sulfur-containing positive electrode material for a secondary battery according to claim 1.

10. The secondary battery according to claim 9, wherein the negative electrode is lithium, sodium, potassium, magnesium, calcium or aluminum.

11. A preparation method of the sulfur-containing positive electrode material for a secondary battery according to claim 1, wherein elemental sulfur and microporous polyacrylonitrile are mixed according to a mass ratio of (3-8):1, heated to 300° ° C.-400° C., and heat preserved for 4-10 h to obtain a vulcanized polyacrylonitrile positive electrode material, that is, the sulfur-containing positive electrode material for the secondary battery.

12. The preparation method of the sulfur-containing positive electrode material for a secondary battery according to claim 7, wherein in the sulfur-containing positive electrode material for the secondary battery, a sulfur content is 50-65 wt %.
